(19) United States
(12) Patent Application Publication
(10) Pub. No.: US 2011/0284514 A1
(43) Pub. Date: Nov. 24, 2011

(54) METHOD TO PROVIDE A HEATED FLUID FROM A FLUID CONTAINER AND HEATING DEVICE FOR COOPERATION WITH A FLUID CONTAINER

(75) Inventor: Willem Koster, Den Ham (NL)

(73) Assignee: Kinetic Inventions BV, Den Ham (NL)

(21) Appl. No.: 13/142,383

(22) PCT Filed: Dec. 22, 2009
(86) PCT No.: PCT/EP2009/067802

§ 371 Date: Aug. 10, 2011

(30) Foreign Application Priority Data
Dec. 27, 2008 (NL) NL2002378

(51) Int. Cl. H05B 1/00

(52) U.S. Cl. 219/201; 219/386

(57) ABSTRACT

The invention relates to a method to provide a heated fluid from a fluid container comprising a fluid having a lower temperature wherein a user provides a kinetic motion which motion results in an electric current, which electric current is directly or indirectly used to heat the fluid The invention is also directed to a heating device, intended for cooperating with a fluid container, equipped with a discharge opening fluidly connected to a nozzle, in which the heating device is equipped with means of attachment for attaching the heating device on to the fluid container and fixing means for connection to a flow opening of the fluid container, a fluid space for the reception of an amount of fluid from the flow opening from the fluid container, means of heating for heating the fluid present in the fluid space and a generator for generating electrical energy for the means of heating

### CROSS-REFERENCE TO RELATED APPLICATION

This application is a national phase filing, under 35 U.S.C. §371(c), of International Application No. PCT/EP2009/067802, filed Dec. 22, 2009, the disclosure of which is incorporated herein by reference in its entirety.

### FEDERALLY SPONSORED RESEARCH OR DEVELOPMENT

Not Applicable

### BACKGROUND

The invention is directed to a method to provide a heated fluid from a fluid container comprising a fluid and to a heating device intended to function together with a fluid container.

The users' experience of a substantial number of liquid products is enhanced by heating the product prior to use. This especially applies to products for personal care or to fluids which have to be administered to the animal or human body, such as vaccines or medicines. For personal care products such as shaving foam or gel heat is usually provided by using hot water. A problem with hot water is that it is not always available.

A device which does not require hot water is described in US-A-2004/226966. This publication describes a heating device, intended for cooperating with a fluid container. The fluid according to this publication is a shaving foam. The heating device has means for heating the fluid and has means to connect with the fluid container. Similar devices are described in U.S. Pat. No. 6,056,160 and EP-A-1912481. All these devices implicitly or explicitly require a power cord for generating the required heat.

### SUMMARY

The present invention aims at providing a method and device to provide a heated fluid from a fluid container in places where no mains electricity supply is available.

This aim is achieved with the following method and device.

Method to provide a heated fluid from a fluid container comprising a fluid having a lower temperature wherein a user provides a kinetic motion which motion results in an electric current, which electric current is directly or indirectly used to heat the fluid.

Heating device, intended for cooperating with a fluid container, equipped with a discharge opening fluidly connected to a nozzle, in which the heating device is equipped with means of attachment for attaching the heating device on to the fluid container and fixing means for connection to a flow opening of the fluid container, a fluid space for the reception of an amount of fluid from the flow opening from the fluid container, means of heating for heating the fluid present in the fluid space and a generator for generating electrical energy for the means of heating.

Applicants have found that a user can generate enough electric energy by means of a kinetic movement for heating up a small volume of liquid. The temperature rise and desired temperature of the liquid as discharged can be controlled making the invention suited for many applications. Preferably the kinetic motion is a shaking hand motion of the user. The shaking motion preferably results in an oscillating movement of a moveable magnet between a first end and a second end along a pathway extending between said two ends. The pathway is enclosed by an inductive coil, such that an alternating electric current is generated when the magnet moves through said coil. The electric current can be used in various manner known to the skilled person to heat the fluid. Preferably the electric current is passed through a filament, suitably a spiral filament. The filament heats up as a result. By contacting the fluid as it is discharged from the fluid container indirectly or directly with the filament the fluid is raised in temperature.

The heated fluid may be any fluid which requires a certain temperature upon use. Preferably the applications are where a small volume of fluid needs to be heated from a temperature at which the fluid is stored in the fluid container. The fluid may be present in a small container, such as a straw comprising frozen sperm. Multiple frozen sperm straws can advantageously be stored in the presence of frozen nitrogen and heated just upon use by the method according to the invention in for example rural environments. The filament to provide the heat is preferably present around the straw and the heat exchange is performed by means of indirect heat exchange. In other applications it is preferred to heat a portion of the fluid as it is discharged from the fluid container. Suitable applications are in the area of personal care products, where it is desirable from a user's point of view to apply the products at a temperature suited for application on the human skin. Especially the invention is directed to the aforementioned shaving foam application, where the fluid is a shaving foam or shaving gel. The method provides a heated shaving foam or gel in areas wherein no mains power and no hot water is present. Other care products are crèmes and massage oils. Another suitable embodiment is wherein the heated fluid is a fluid intended for admission to an animal or human body. Examples of suitable fluids are vaccines, anesthetic fluids, eye creams, eye fluids and ear fluids, which need to be stored at a reduced temperature but need to be administered at a higher temperature. A further embodiment is where the fluid is an adhesive which has a high viscosity and require some heating to make the adhesive more fluid when applied.

The invention is also directed to a heating device, which heating device is especially suited to perform the method described above. According to the invention, the fluid space of the heating device is filled with fluid from the fluid container, after which electric energy is generated by means of a generator. This energy heats up the means of heating in such a way that the temperature of the fluid present in the fluid space is increased. Subsequently, the heated fluid can be taken from the fluid space and used.

In the heating device according to the invention, the means of heating preferably enclose the fluid space. In this way, the transfer of heat is optimal and the means of heating takes up little space. One very suitable means of heating for this invention is for example a resistive filament, preferably a spiral filament. A filament is advantageous because it can be heated up relatively rapidly and, furthermore, it can be produced simply and cheaply.

In a practical embodiment of the heating device according to the invention, the fluid space mainly forms a channel. The channel is preferably tubular, in which the diameter more or less corresponds with the flow opening of the fluid container. In this manner the effective fluid surface is increased, thereby increasing the efficiency of the means of heating.

The channel is preferably pressure proof and fluid proof. This allows the application of the heating device according to the invention to a pressurized fluid container.

In preferred embodiment of the heating device according to the invention, the fluid space stretches out through to the generator. A generator takes up a relatively great amount of space, leaving little room for the fluid space. This disadvantage is neutralised by stretching the fluid space out through to the generator.

The heating device according to the invention is equipped with a generator, which converts a shaking motion of the heating device into electric energy. This energy is always available and the user does not have to depend on batteries or the electric grid. A suitable generator is described in U.S. Pat. No. 5,975,714, which publication is hereby incorporated by reference. This preferred generator is provided with a casing, in which a magnet can be moved along the longitudinal axis in the casing. Preferred magnets have a high magnetic field. Preferably the magnet is a neodymium magnet. The casing may suitable have magnets, springs or other means fixed on the ends in such a way that the moveable magnet is repelled so as to avoid shock impacts at each end of the travel of the moveable magnet. Preferably magnets are present at both ends. The casing is partly covered by an inductive coil. Due to a shaking movement along the longitudinal axis of the casing, the moveable magnet of the generator is moved in an oscillating movement between the first and second ends, whereby the optional fixed magnets at the ends of the casing provide a return impulse to the moveable magnet. Due to this oscillating movement of the moveable magnet, alternating current is generated in the inductive coil. A converter converts this current into direct current and this supplies an electric current. In order to store the energy as generated by the generator the heating device according to the invention is equipped with a means of storage. A very suitable means of storage is a capacitor, especially a capacitor that combines a high capacity with a small size.

Preferably the casing of the generator is provided with a cavity for passage of the fluid space as will be illustrated in the Figures. The heating device according to the invention is especially suited for cooperation with a fluid container intended for care products, such as shaving foam or shaving gel.

### BRIEF DESCRIPTION OF THE DRAWINGS

The heating device according to the invention will be explained in further detail on the basis of three figures, in which:

FIG. 1 shows the heating device according to the invention as placed on a fluid container;

FIG. 2 shows a section of the heating device according to the invention;

FIG. 3 shows a cross section of the heating device according to the invention.

### DETAILED DESCRIPTION

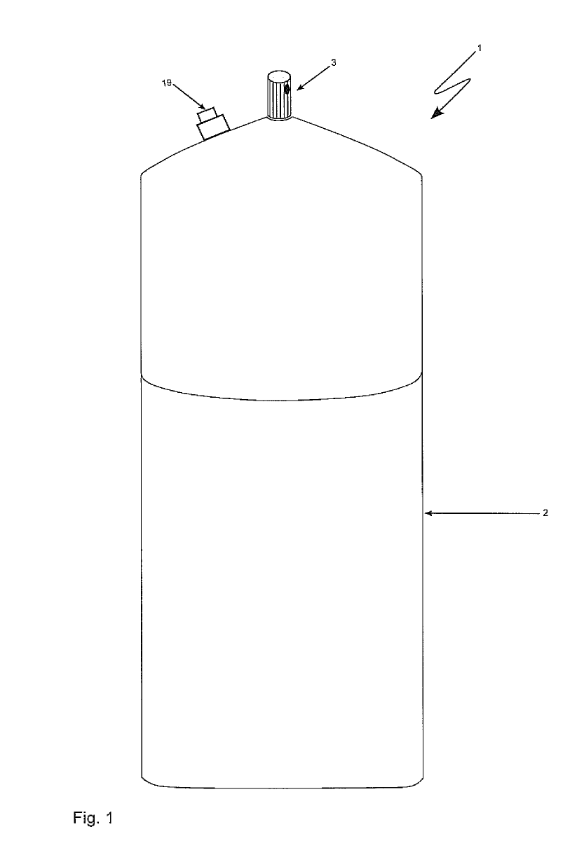

FIG. 1 shows the heating device (1) according to the invention as placed on a fluid container 2. By way of example, the container 2 is a pressurized container so that the fluid contained in it can be dispensed by opening a valve (not shown) by pressing a nozzle 3. The container 2 may be of standard form, and for normal use the nozzle 3 and the valve would be fitted at the upper end of a tube 21 extending to the bottom of the container 2. In the application of the heating device (1) according to the invention, the nozzle from the fluid container (2) is removed first.

Subsequently, the heating device (1) is attached to the fluid container (2) so that it is rigidly secured to the container 2. The nozzle 3 is then refitted to the top end of a heater tube 6 which defines a fluid space 20. Subsequent pressing of the nozzle 3 acts through the heater tube 6 to open the valve at the top end of the tube 21. The user only has to fill the fluid space 20 in the heating device for the first time usage by pressing the nozzle (3) of the heating device. After shaking the system of the heating device (1) and the fluid container (2) and then pressing switch 19, the fluid in the fluid space of the heating device is heated up. The user can release the heated fluid from the heating device (1) by pressing the nozzle (3), while a new amount of fluid from the container (2) flows into the fluid space 20.

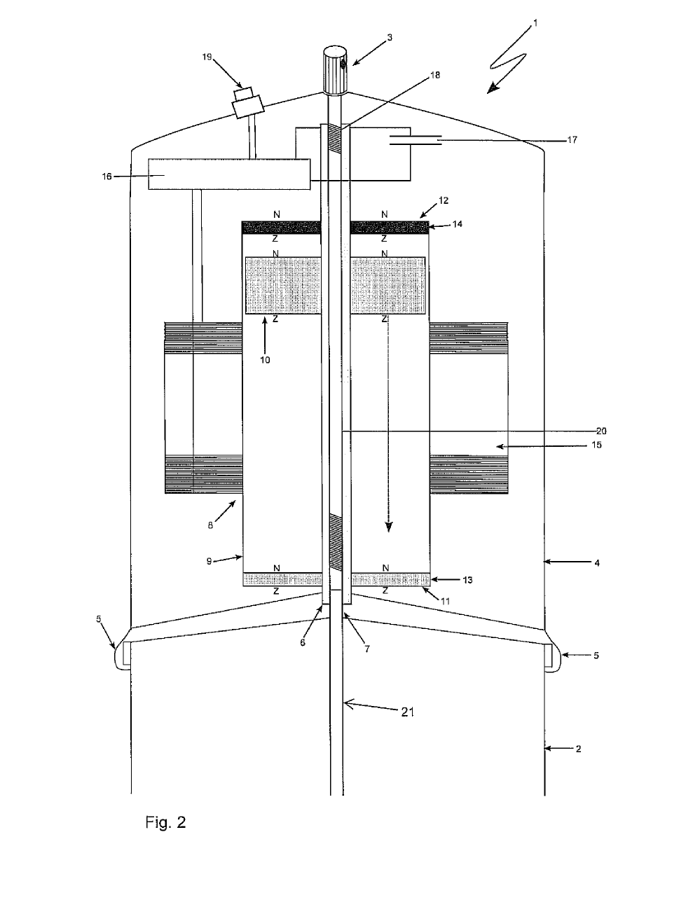

FIG. 2 shows a section of the heating device (1) according to the invention.

The heating device is provided with a casing (4) of which the shape and size preferably connect aesthetically to the fluid container (2). The heating device (1) is provided with means of attachment (5) for attaching the heating device (1) to the fluid container (2) with the heater tube (6) attached to a flow opening (7) of the tube 21 of the fluid container (2). Both the means of attachment (5) and interface between the heater tube 6 and the container tube 21 depend on the type of container (2) and can be realised by methods known in this technical area.

A generator (8) is situated in the casing (4) of the heating device (1) and is equipped with a casing (9), a moveable magnet (10), which is preferably ring-shaped, whereby the casing (9) is equipped with magnets (13, 14) on the ends (11, 12). These magnets are installed in such a way that they repel the moveable magnet (10) and the casing (9) is partly enclosed by an inductive coil (15). The fluid space (20) for the reception of a portion of the fluid from the fluid container (2) runs through the casing (9). The magnet (10) preferably has a magnetic flux density of 1.4 Tesla.

By shaking the heating device (1), the magnet (10) will make an oscillating movement between the first end (11) and second end (12) of the casing (9), during which the magnet (10) is repelled by magnets (13) and (14). This movement of magnet (10) through the inductive coil (15) generates an alternating current, which is rectified by means of an AC/DC converter on a printed circuit board (16) and is subsequently used for charging a capacitor (17). When the magnet (10) is moved to and fro in the inductive coil (15), the following current is generated in the inductive coil (15).

V=Vₚₑₐₖ(sin(ωt))wherein Vₚₑₐₖ=(N)(B)(A)(ω)and ω=π/T

The Vpeak is the maximum peak voltage of the sine wave pulse generated, N the number of windings of the coil (15), B the strength of the magnetic field of the magnet (10) (in Tesla), A the cross-section area of the coil (15) (in m2) and T the pulse duration (in sec).

To illustrate the present invention the following example describes a situation wherein N=1472, B=0.54 T, A=0.0006 m2 and T=0.06 seconds, which may be considered to be practical values.

In theory, Vpeak amounts to 25 Volt, however, in practice, 21 Volt is measured.

The capacity is determined by the formula:

$$P = \frac{{V}^{2 }}{R} wherein R = \frac{( z ) ( ϱ )}{a}$$

in which R is the resistance of the coil (15), z the total length of the wound coil wire (in meters), p is the resistance of the wire (in Ohm/meter) and a the surface of the section of the coil (15) (in m2).

The capacity as a function of time (J/sec) is:

E=∫₀^{t}P dt=∫₀^{t}10.25(sin²52t)dt

In which z=137 meters, ρ=1.7×10−8, en a=5×10−8 m².

In this example a capacity generation of 5 Joule/sec is feasible. This can heat up 2 ml of water 20 degrees Celsius within 40 seconds.

The printed circuit board (16) also contains control components for charging the capacitor (17) and discharging the capacitor (17), during which the energy released is moved to a resistive spiral filament (18) and the fluid present in the fluid space (20) is heated up. The discharge of the capacitor (17) is started by pressing the switch (19), which is also connected to the printed circuit board (16). The duration of pressing the switch (19) and the amount of current in the capacitor (17) are decisive for the final temperature of the fluid present in the fluid space. However, the capacitor's discharge can also take place in other ways. The switch (19) can also be connected to the nozzle (3) in such a way that the fluid present in the fluid space is heated up as soon as the nozzle (3) is pressed.

Additionally, the heating device (1) can contain a motion sensor for activating the discharging of the capacitor (17) as soon as the heating device is moved.

The fluid present in the fluid space (20) can subsequently be released by pressing the nozzle (3) and a new amount of fluid released from the container (2) replaces the fluid released.

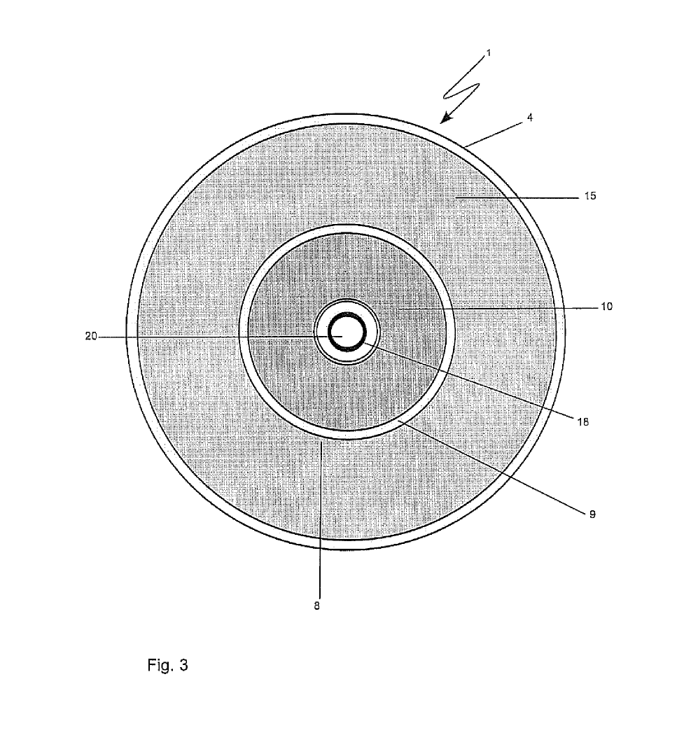

FIG. 3 shows a cross-section of the heating device (1) according to the invention seen from above at the level of slanting top of the heating device (1). For the sake of clarity, the printed circuit board (16), capacitor (17) and magnet (14) were omitted. The cross-section of the heating device (1) is ring-shaped and for illustrating purposes, the elements of the heating device (1) were attuned to this. The fluid space (20) runs through the middle of the heating device (1) and is surrounded by the spiral filament (18). The ring-shaped casing (9) of the generator (8) is enclosed by the inductive coil (15). The magnet (10) also has a ring-shaped size and fits in the ring-shaped casing (9). The magnet (10) also has a cut-away for the fluid space (20) to pass through.

The invention is also directed to a kit of parts comprising (i) a heating device as described above and (ii) a fluid container intended for cooperating with the heating device. The invention also is directed to fluid containers solely intended for use in cooperation with the heating device according to the invention.

Another possible kit of parts according to this invention comprises (iii) a generator suited to generate an electric current provided with a casing, a moveable magnet that can be moved in the casing along the longitudinal axis of the casing by means of shaking and which casing is partly enclosed by an inductive coil, such that in use an alternating electric current is generated, (iv) a fluid container having a fluid discharge channel provided with a means of heating for heating the fluid and (v) connecting means to provide the electric current from generator (iii) to fluid container (iv). Such a combination is advantageous because it separates the fluid container and its discharge from the device which generates the electric current. The more complex generator (iii) can thus be separated from the fluids, thereby avoiding damaging the generator. The more damage sensitive heating filament can then be present in the discharge channel of the, disposable, fluid container. The invention is also directed to this fluid container having a fluid discharge channel provided with a means of heating for heating the fluid as present in the fluid container.

Thus, although FIGS. 1 to 3 show an embodiment in which the container 2 and the heater 1 are rigidly connected together, an alternative possibility is for them to be separate, although interconnected electrically. In such a case, the heating device can be shaken while the container remains stationary.

The above method is preferably used in the heating device according or the kit of parts as described above.

Finally and explicitly, this invention is not limited to the described and illustrated embodiments, but generally covers any embodiment within the scope of the claims and in the context of the description and figures.

1-24. (canceled)

25. A method of providing a heated fluid from a container containing a fluid having a lower temperature, the method comprising:
providing a kinetic motion to the container;
employing the kinetic motion to generate an electric current through a filament in the container whereby the filament is heated;
directing the fluid in the container through a tube provided in the container in proximity to the heated filament, so that the heated filament heats the fluid flowing through the tube; and
discharging the heated fluid from the container through the tube.

26. The method according to claim 25, wherein the kinetic movement is a manual shaking movement.

27. The method according to claim 26, wherein the shaking motion results in an oscillating movement of a moveable magnet between a first end and a second end of a pathway extending between said two ends, and wherein the pathway is enclosed by an inductive coil, such that an alternating electric current is generated in the coil.

28. The method according to claim 25, wherein the heated fluid is selected from the group consisting of a shaving foam, a shaving gel, a vaccine, an anesthetic fluid, an eye cream, an eye treatment fluid, and an ear treatment fluid.

29. The method according to claim 26, wherein the heated fluid is selected from the group consisting of a shaving foam, a shaving gel, a vaccine, an anesthetic fluid, an eye cream, an eye treatment fluid, and an ear treatment fluid.

30. The method according to claim 27, wherein the heated fluid is selected from the group consisting of a shaving foam, a shaving gel, a vaccine, an anesthetic fluid, an eye cream, an eye treatment fluid, and an ear treatment fluid.

31. The method according to claim 25, wherein the heated fluid contains sperm.

32. The method according to claim 26, wherein the heated fluid contains sperm.

33. The method according to claim 27, wherein the heated fluid contains sperm.

34. A heating device configured for cooperating with a fluid container having a flow opening, the device comprising:
a nozzle;
a discharge opening fluidly connected to the nozzle;
means for attaching the heating device to the fluid container;
a tube fluidly connecting the discharge opening to the flow opening of the fluid container when the heating device is attached to the fluid container, the tube defining a fluid space configured for the reception of fluid from the flow opening of the fluid container;
a heating element operable for heating the fluid in the fluid space; and
a generator operable for generating electrical energy for the heating element.

35. The heating device according to claim 34, wherein the heating element at least partially surrounds the fluid space.

36. The heating device according to claim 34, wherein the heating element comprises a spiral filament.

37. The heating device according to claim 35, wherein the heating element comprises a spiral filament.

38. The heating device according to claim 34, wherein the generator is configured to convert a shaking movement into electric energy.

39. The heating device according to claim 35, wherein the generator is configured to convert a shaking movement into electric energy.

40. The heating device according to claim 38, wherein the generator comprises:
a casing defining a longitudinal axis;
a moveable magnet that is moveable in the casing along the longitudinal axis of the casing by means of shaking; and
an inductive coil at least partially enclosing the casing, such that an alternating electric current is generated in the coil in response to the movement of the moveable magnet.

41. The heating device according to claim 39, wherein the generator comprises:
a casing defining a longitudinal axis;
a moveable magnet that is moveable in the casing along the longitudinal axis of the casing by means of shaking; and
an inductive coil at least partially enclosing the casing, such that an alternating electric current is generated in the coil in response to the movement of the moveable magnet.

42. The heating device according to claim 40, wherein the casing has first and second ends, and wherein the device further comprises a fixed magnet at the each of the first and second ends of the casing such that the moveable magnet is repelled by each of the fixed magnets.

43. The heating device according to claim 41, wherein the casing has first and second ends, and wherein the device further comprises a fixed magnet at the each of the first and second ends of the casing such that the moveable magnet is repelled by each of the fixed magnets.

44. Apparatus for heating a fluid, comprising:
a fluid space for accommodating the fluid;
an electric heater for heating fluid in the fluid space;
an electrical generator connected to supply electricity to the heater, the generator including a movable element which is movable by manual kinetic movement imparted to the generator, thereby to generate electricity; and
a container for containing the fluid, wherein the fluid space comprises a flow passage for the flow of fluid from the container.

45. Apparatus according to claim 44, wherein the electric heater comprises a spiral filament.

46. Apparatus according to claim 45, wherein the generator is designed to convert a shaking movement into electric energy.

47. Apparatus according to claim 46, wherein the generator is designed to convert a shaking movement into electric energy.

48. Apparatus in accordance with claim 46, wherein the generator comprises:
a casing defining a longitudinal axis;
a moveable magnet that is moveable in the casing along the longitudinal axis of the casing by means of shaking; and
an inductive coil at least partially enclosing the casing, such that an alternating electric current is generated in response to the movement of the moveable magnet.

49. Apparatus in accordance with claim 47, wherein the generator comprises:
a casing defining a longitudinal axis;
a moveable magnet that is moveable in the casing along the longitudinal axis of the casing by means of shaking; and
an inductive coil at least partially enclosing the casing, such that an alternating electric current is generated in response to the movement of the moveable magnet.

50. Apparatus according to claim 48, wherein the casing has first and second ends, and wherein the device further comprises a fixed magnet at the each of the first and second ends of the casing such that the moveable magnet is repelled by each of the fixed magnets.

51. Apparatus according to claim 49, wherein the casing has first and second ends, and wherein the device further comprises a fixed magnet at the each of the first and second ends of the casing such that the moveable magnet is repelled by each of the fixed magnets.
